(19) United States
(12) Patent Application Publication
(10) Pub. No.: US 2025/0005990 A1
(43) Pub. Date: Jan. 2, 2025

(54) CURRENCY PROCESSING APPARATUS AND CURRENCY PROCESSING METHOD

(71) Applicant: Glory Ltd., Himeji-shi (JP)

(72) Inventors: Hideki TAKATA, Himeji-shi (JP); Shoji KAJITA, Himeji-shi (JP); Masashi KUWADA, Himeji-shi (JP); Ren NAGAYOSHI, Himeji-shi (JP)

(73) Assignee: Glory Ltd., Himeji-shi (JP)

(21) Appl. No.: 18/885,783

(22) Filed: Sep. 16, 2024

Related U.S. Application Data
(63) Continuation of application No. PCT/JP2023/009621, filed on Mar. 13, 2023.

(30) Foreign Application Priority Data
Mar. 17, 2022 (JP) 2022-042048

(51) Int. Cl. G07D 11/16; G07D 11/22

(52) U.S. Cl. CPC G07D 11/16; G07D 11/22

(57) ABSTRACT

A money handling apparatus includes: an input receptacle configured to send out money to be received, into the apparatus; a transport member having a transport path connected to the input receptacle, and configured to transport the money sent out from the input receptacle; a recognition circuit configured to recognize the money and output a recognition signal; a first storage to which the transport path is connected, and which is configured to store recognized money; and a controller configured to, in a receiving process, determine whether or not the money to be received is money to be digitized, based on the recognition signal, and output a control signal so that money to be digitized is stored in the first storage.

### CROSS-REFERENCE TO RELATED APPLICATIONS

This application is a bypass continuation of International Patent Cooperation Treaty Application No. PCT/JP2023/009621 filed on Mar. 13, 2023, and claims priority to Japanese Patent Application No. 2022-042048 filed on Mar. 17, 2022, the entire disclosures of which each are incorporated herein by reference.

### BACKGROUND

A conventional technology in which a device connected to a cash grid, e.g., an automatic teller machine (ATM), converts physical money into digital currency, has been known. The digital currency is managed in the cash grid. It is also known that such a device invalidates the physical money converted into the digital currency by cutting, for example.

A conventional system also converts physical money into digital currency. A user can convert physical money into digital currency by providing the physical money to an ATM, for example. The physical money converted into the digital currency is removed from circulation by a central bank.

Meanwhile, a conventional technology for safely transporting physical money has been known. Specifically, the conventional transporting technology includes a transport procedure as follows. Firstly, a first cash handling machine takes photographs of money being transported, and transmits the photographs to a second cash handling machine. Next, the first cash handling machine cuts, for example, the letters “INVALID”, from the money by using a laser cutter, thereby invalidating the physical money. The invalidated money is transported to the second cash handling machine. Since the money is invalidated, the money can be safely transported. The second cash handling machine takes the invalidated money therein, and converts the invalidated money into digital currency. The digital currency is managed by a block chain, for example. Moreover, the second cash handling machine completely destroys the invalidated money by using a shredder, for example.

### SUMMARY

The technology disclosed herein relates to a money handling apparatus. The money handling apparatus includes: an input receptacle receiving money and sending out the money into the apparatus; a transport member having a transport path connected to the input receptacle, and transporting the money sent out from the input receptacle; a recognition circuit recognizing money and outputting a recognition signal; a first storage to which the transport path is connected, and which stores recognized money; and a controller configured to, in a receiving process, determine whether or not the money to be received is money to be digitized, based on the recognition signal, and output a control signal so that money to be digitized is stored in the first storage.

### BRIEF DESCRIPTION OF THE DRAWINGS

FIG. 1 illustrates a money handling apparatus.

FIG. 2 illustrates a procedure of a receiving process.

FIG. 3 illustrates a data structure of digital currency.

FIG. 4 illustrates a money transport path.

FIG. 5 illustrates a data structure of digital currency when substitute money is used.

FIG. 6 illustrates a procedure of a money change process.

FIG. 7 illustrates an exemplary money handling apparatus.

FIG. 8 illustrates an exemplary money handling apparatus.

### DETAILED DESCRIPTION OF THE DRAWINGS

The conventional devices handle both the money to be converted into digital currency and the money not to be converted into digital currency, but, unfortunately, cannot determine whether or not to convert money into digital currency.

The technology disclosed herein discriminates between money to be digitized and money not to be digitized.

The technology disclosed herein relates to a money handling apparatus. The money handling apparatus includes: an input receptacle receiving money and sending out the money into the apparatus; a transport member having a transport path connected to the input receptacle, and transporting the money sent out from the input receptacle; a recognition circuit recognizing money and outputting a recognition signal; a first storage to which the transport path is connected, and which stores recognized money; and a controller configured to, in a receiving process, determine whether or not the money to be received is money to be digitized, based on the recognition signal, and output a control signal so that money to be digitized is stored in the first storage.

The money handling apparatus can discriminate between money to be digitized and money not to be digitized, based on the recognition signal.

The receiving process is, in a broad sense, a process of taking physical money into the money handling apparatus. The receiving process includes a replenishment process of storing physical money into the money handling apparatus, and a money change process of taking money as a source of money change into the apparatus and dispensing equivalent money, in addition to a process of depositing money to be received into a designated account. Moreover, the receiving process further includes a process in which a change machine as a money handling apparatus takes in money at the time of settlement, and dispenses a change.

The money handling apparatus may further include an invalidation device connected to the first storage, and invalidating the money to be digitized. The first storage may store invalidated money.

The money to be digitized, stored in the first storage, is an unusable banknote. The money handling apparatus can safely manage money.

The controller may be configured to output a depositing signal so that, in the receiving process, digital currency into which the money to be received is converted is deposited in a designated account.

The user can convert the physical money inserted in the money handling apparatus into digital currency, and deposit the digital currency in the designated account (bank account or digital wallet).

The controller may be configured to output a depositing signal so that, in the receiving process, money equivalent in value to the money to be received is deposited in the designated account.

The user can deposit the physical money inserted in the money handling apparatus into the designated account (bank account or digital wallet) without converting the physical money into digital currency.

The controller may be configured to determine whether or not the money to be received is money to be digitized, based on at least one of version information, fitness information, currency information, and denomination information, of the money to be received, which correspond to the recognition signal.

The money handling apparatus may determine that, for example, old series notes are to be digitized and new series notes are not to be digitized. The money handling apparatus may determine that, for example, unfit notes are to be digitized and fit notes are not to be digitized. The money handling apparatus may determine that, for example, a domestic currency is to be digitized and foreign currencies are not to be digitized. The money handling apparatus may determine that, for example, large-denomination money is to be digitized and small-denomination money is not to be digitized.

The controller may be configured to determine whether or not the money to be received is money to be digitized, based on an identification number, of the money to be received, which corresponds to the recognition signal.

The money handling apparatus may determine that, for example, stolen money or counterfeit money is not to be digitized, based on the identification number.

The money handling apparatus may further include a return port to which the transport path is connected, and which is configured to hold money to be returned. The controller may be configured to output the control signal so that money not to be digitized is returned to the return port.

The money handling apparatus can return the money not to be digitized to the user.

The money handling apparatus may further include a second storage to which the transport path is connected, and which stores money not to be digitized.

The money handling apparatus can manage the money to be digitized and the money not to be digitized separately from each other by using the first storage and the second storage.

The money handling apparatus may further include a third storage to which the transport path is connected, and which stores substitute money for the money not to be digitized. The controller may be configured to output a control signal so that, when the second storage stores the money not to be digitized, the substitute money is converted into digital currency. Furthermore, the controller may be configured to output a depositing signal so that converted digital currency is deposited in a designated account.

Even if the money to be received is money not to be digitized, the user can use the digital currency into which the substitute money is converted. For example, the user can deposit, in the account, the digital currency into which the substitute money is converted.

The controller may be configured to output a control signal so that the substitute money fed out from the third storage is stored in the first storage.

The money handling apparatus can manage the substitute money as money to be digitized.

Information on the digital currency may include both information on the money to be received and not to be digitized, and information on the substitute money.

Management of the information on digital currency is optimized.

A money handling apparatus disclosed herein includes: a input receptacle receiving money and sending out the money into the apparatus; a transport member having a transport path connected to the input receptacle, and transporting the money sent out from the input receptacle; a first storage to which the transport path is connected, and which stores money to be digitized among the money to be received; a third storage to which the transport path is connected, and which feeds out money stored therein; and a controller configured to, in a receiving process, output a control signal so that substitute money for money not to be digitized among the money to be received is fed out from the third storage, and the substitute money is stored in the first storage as the money to be digitized.

Even when the money to be received, which is taken into the apparatus, is not to be digitized, the money handling apparatus can convert the substitute money into digital currency.

The money handling apparatus may further include an invalidation device connected to the first storage, and invalidating the money to be digitized, and the first storage may store the invalidated money.

The money handling apparatus can invalidate the substitute banknote having been digitized, and safely manage the substitute banknote.

The third storage may feed out one or a plurality of pieces of substitute money equivalent in value to the money not to be digitized.

The substitute money is not limited to money of the same denomination as the money not to be digitized. The substitute money may be smaller-denomination money than the money not to be digitized.

A money handling method disclosed herein includes: sending out, by a input receptacle, money to be received into a money handling apparatus; recognizing, by a recognition circuit, the money to be received and outputting a recognition signal; determining, by a controller, whether or not the money to be received is money to be digitized, based on the recognition signal; transporting, by a transport member, money to be digitized to a first storage, upon receiving determination of the controller; and storing the money to be digitized in the first storage.

Another money handling method disclosed herein includes: sending out, by a input receptacle, money to be received into a money handling apparatus; storing, in a first storage, money to be digitized among the money to be received; feeding out, by a third storage, substitute money for money not to be digitized among the money to be received; and storing, in the first storage, the substitute money as money to be digitized.

Hereinafter, embodiments of a money handling apparatus will be described with reference to the drawings. The money handling apparatus described here is an example.

### First Embodiment

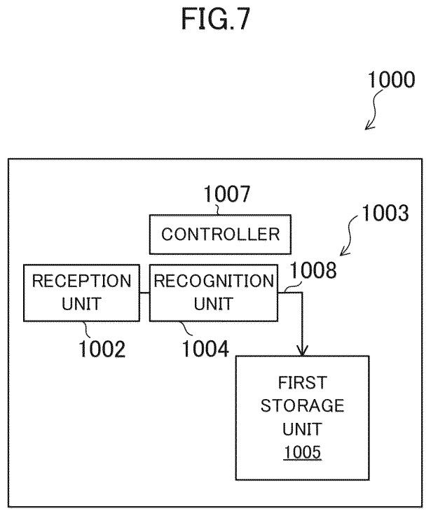

FIG. 7 exemplarily illustrates a money handling apparatus 1000. The money handling apparatus 1000 includes a reception unit 1002, a transport unit 1003, a recognition unit 1004, a first storage unit 1005, and a controller 1007.

The money handling apparatus 1000 is installed in, for example, a service office of a bank. The installation place of the money handling apparatus 1000 is not limited. The money handling apparatus 1000 performs a receiving process for money according to a user's operation. The money handling apparatus 1000 may be a so-called ATM. The money handling apparatus 1000 may be an apparatus that is operated by a teller of a bank. Money is banknotes, coins, or both banknotes and coins. The receiving process may be, for example, a process in which the money handling apparatus 1000 stores therein physical money to be received, and deposits money equivalent in value to the physical money stored in the apparatus, into a bank account. The bank account is an account of the user who performs the depositing process, or an account of another person designated by the user.

The money handling apparatus 1000 may convert a part or all of physical money to be received into digital currency. The money handling apparatus 1000 may further perform a process of depositing the digital currency into a bank account or a digital wallet. In this case as well, the bank account is an account of the user who performs the depositing process, or an account of another person designated by the user. The digital wallet is a digital wallet of the user who performs the depositing process, or a digital wallet of another person designated by the user. The digital wallet can be implemented by, for example, electronic equipment such as a smartphone, a smartwatch, a tablet, or a computer, and the user can perform settlement by using the electronic equipment. Whether or not conversion into digital currency is necessary depends on a recognition signal that is outputted by the recognition unit 1004 as a result of recognition of physical money to be received. Whether or not conversion into digital currency is necessary may be based on an operation signal corresponding to a user's operation. The receiving process may be a money change process of converting physical money to be received into digital currency, and dispensing the digital currency. The receiving process may be a replenishment process of converting physical money to be received into digital currency, and storing the digital currency into a memory inside the apparatus. The receiving process may be a settlement process of converting physical money to be received into digital currency, and dispensing the digital currency as a change.

The reception unit 1002 is an input receptacle with a mechanical structure. The user inserts physical money to be received into the reception unit 1002. The reception unit 1002 sends out the inserted money to be received, into the money handling apparatus 1000.

The transport unit 1003 is a transport member with a mechanical structure. The transport unit 1003 includes a transport path 1008 connected to the reception unit 1002. The transport unit 1003 transports the money sent out from the reception unit 1002 along the transport path 1008.

The recognition unit 1004 is a recognition circuit that includes at least one sensor. The recognition unit 1004 is located on the transport path 1008. The recognition unit 1004 recognizes the money being transported, and outputs a recognition signal to the controller 1007. The recognition unit 1004 recognizes at least the denomination of the money.

The first storage unit 1005 is a storage with a structure. The first storage unit 1005 stores the recognized money. The transport path 1008 is connected to the first storage unit 1005.

The controller 1007 is a circuitry. The controller 1007 outputs a control signal to the transport unit 1003. More specifically, in the receiving process, the controller 1007 determines whether or not the money to be received is money to be digitized, based on the recognition signal. The money handling apparatus 1000 can discriminate between money to be digitized and money not to be digitized, based on the recognition signal. Moreover, the controller 1007 outputs the control signal to the transport unit 1003 so that the money to be digitized is stored in the first storage unit 1005. The first storage unit 1005 stores the money to be digitized.

### Second Embodiment

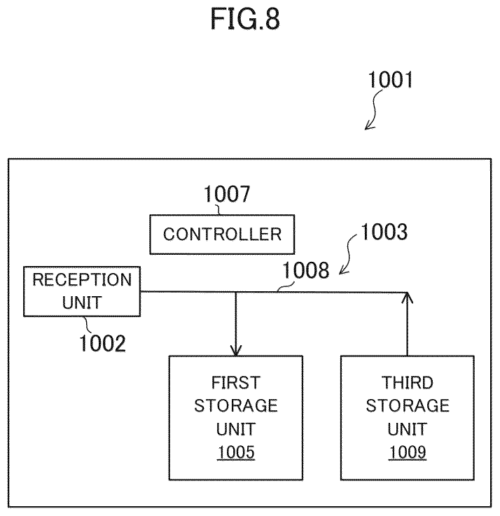

FIG. 8 exemplarily illustrates a money handling apparatus 1001. The money handling apparatus 1001 is a modification of the money handling apparatus 1000 shown in FIG. 7. The money handling apparatus 1001 includes a reception unit 1002, a transport unit 1003, a first storage unit 1005, a third storage unit 1009, and a controller 1007.

The user inserts physical money to be received into the reception unit 1002. The reception unit 1002 sends out the inserted money to be received into the money handling apparatus 1001.

The transport unit 1003 includes a transport path 1008 connected to the reception unit 1002. The transport unit 1003 transports the money sent out from the reception unit 1002 along the transport path 1008.

The first storage unit 1005 stores money to be digitized among the money to be received. The transport path 1008 is connected to the first storage unit 1005.

The transport path 1008 is connected to the third storage unit 1009. The third storage unit 1008 is a storage with a structure. The third storage unit 1009 feeds out the stored money.

The controller 1007 outputs control signals to the transport unit 1003 and the third storage unit 1009. Specifically, the controller 1007 outputs the control signal to the third storage unit 1009 so that, in the receiving process, substitute money for the money not to be digitized among the money to be received is fed out. The third storage unit 1009 feeds out the substitute money. The substitute money is one or a plurality of pieces of physical money that is equivalent in value to the money not to be digitized. Moreover, the controller 1007 outputs the control signal to the transport unit 1003 so that the substitute money is stored in the first storage unit 1005. The first storage unit 1005 stores the substitute money as the money to be digitized.

### Third Embodiment

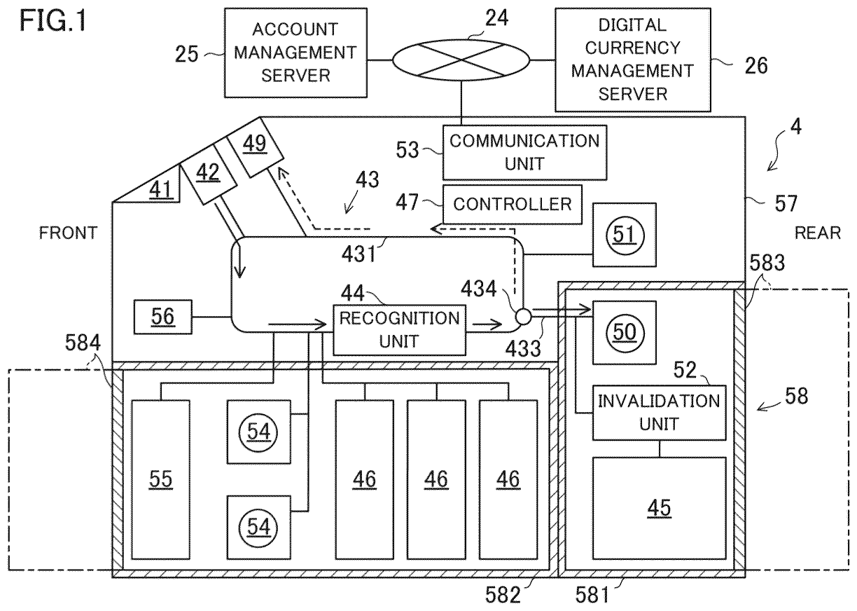

FIG. 1 illustrates a money handling apparatus 4 according to a third embodiment. The money handling apparatus 4 is a modification of either of the money handling apparatus 1000 shown in FIG. 7 and the money handling apparatus 1001 shown in FIG. 8. The money handling apparatus 4 is a banknote handling apparatus that handles banknotes. The money handling apparatus 4 may be a coin handling apparatus that handles coins, or may be a money handling apparatus that handles both banknotes and coins.

The money handling apparatus 4 includes an input unit 41, a reception unit 42, a transport unit 43, a recognition unit 44, a first storage unit 45, and a controller 47. The money handling apparatus 4 further includes second storage units 46, a dispensing unit 49, a first temporary storage unit 50, a second temporary storage unit 51, an invalidation unit 52, a communication unit 53, third storage units 54, a fourth storage unit 55, and a fifth storage unit 56.

Like the money handling apparatus 1000 or the money handling apparatus 1001, the money handling apparatus 4 is installed in a service office of a bank. The installation place of the money handling apparatus 4 is not limited. The money handling apparatus 4 is capable of performing a process of converting a part or all of physical banknotes to be received into digital currency, and depositing the digital currency into a bank account or a digital wallet.

The housing of the money handling apparatus 4 is separated into an upper housing 57 and a lower housing 58. The upper housing 57 forms an upper part of the money handling apparatus 4. The lower housing 58 forms a lower part of the money handling apparatus 4.

The transport unit 43, the recognition unit 44, the controller 47, the second temporary storage unit 51, the communication unit 53, and the fifth storage unit 56 are housed in the upper housing 57 of the money handling apparatus 4. At least parts of the input unit 41, the reception unit 42, and the dispensing unit 49 are exposed to the outside of the upper housing 57 so that the user can access them. The first storage unit 45, the second storage units 46, the first temporary storage unit 50, the invalidation unit 52, the third storage units 54, and the fourth storage unit 55 are housed in the lower housing 58.

The input unit 41 is located at an upper part of a front part of the money handling apparatus 4. The front part of the money handling apparatus 4 is on the left side of the sheet surface of FIG. 1, where the input unit 41, the reception unit 42, and the dispensing unit 49 are located. The reception unit 42 and the dispensing unit 49 are also located at the upper part of the front part of the money handling apparatus 4. The user can easily access the input unit 41, the reception unit 42, and the dispensing unit 49.

The input unit 41 is a touch-panel display mounted to the money handling apparatus 4, or an encrypting pin pad (EPP). The user can perform an input operation by using the input unit 41. The input unit 41 may be a receiver that receives an input signal transmitted from a mobile device (e.g., smartphone) of the user or an external computer. The input signal is a signal corresponding to the user's input operation. The input unit 41 outputs an operation signal corresponding to the user's operation to the controller 47.

The reception unit 42 holds physical banknotes. The user inserts physical banknotes to be received into the reception unit 42. The reception unit 42 sends out the inserted banknotes to be received into the money handling apparatus 4.

The dispensing unit 49 holds physical banknotes to be dispensed. The physical banknotes to be dispensed are sent out from the money handling apparatus 4 to the dispensing unit 49. The user can manually take out the physical banknotes held in the dispensing unit 49. The money handling apparatus 4 may not necessarily include the dispensing unit 49. The money handling apparatus 4 may be an apparatus that does not perform a dispensing process. The reception unit 42 and the dispensing unit 49 may be integrated with each other. That is, in the money handling apparatus 4, a part that holds the banknotes to be received may be the same as a part that holds the banknotes to be dispensed.

The transport unit 43 is mainly housed in the upper housing 57. The transport unit 43 has a loop transport path 431. The transport unit 43 transports a banknote in a positive direction (counterclockwise direction on the sheet surface in FIG. 1) and a negative direction (clockwise direction on the sheet surface) along the loop transport path 431. The reception unit 42 and the dispensing unit 49 are each connected to the loop transport path 431. The shape of the transport path is not limited to a loop.

The recognition unit 44 is located on the loop transport path 431. The recognition unit 44 recognizes each banknote, and outputs a recognition signal to the controller 47.

The lower housing 58 is a safe housing. The lower housing 58 protects items stored therein more securely than the upper housing 57. The lower housing 58 includes a first storage section 581 and a second storage section 582. The first storage section 581 is located in a rear part of the money handling apparatus 4. The second storage section 582 is located in front of the first storage section 581. The first storage section 581 has a first open/close door 583. The first open/close door 583 is located at the rear side of the money handling apparatus 4, and allows the first storage section 581 to be opened toward the back (see an alternate long and short dash line in FIG. 1). The second storage section 582 has a second open/close door 584. The second open/close door 584 is located at the front side of the money handling apparatus 4, and allows the second storage section 582 to be opened toward the front (see an alternate long and short dash line in FIG. 1).

The first open/close door 583 and the second open/close door 584 are each lockable. An authority to unlock the first open/close door 583 may be the same as or different from an authority to unlock the second open/close door 584. The first storage section 581 stores banknotes to be digitized and to be invalidated, as described later. The second storage section 582 stores banknotes not to be digitized. Making the authority to unlock the first open/close door 583 different from the authority to unlock the second open/close door 584 is preferable in terms of the operation of the money handling apparatus 4 performing the digital depositing process.

The first storage unit 45 stores the recognized banknotes. The first storage unit 45 cannot feed out the stored banknotes.

The first storage unit 45 is connected to a branching transport path 433 that branches from the loop transport path 431. A diverter 434 is disposed at a connection point of the loop transport path 431 and the branching transport path 433. The diverter 434 is positioned between the recognition unit 44 and the second temporary storage unit 51 described later. Upon receiving a control signal from the controller 47, the diverter 434 changes the banknote transport direction. The diverter 434 sends a banknote being transported along the loop transport path 431, selectively to the branching transport path 433. In addition, the diverter 434 sends a banknote being transported along the branching transport path 433, to the loop transport path 431.

The first temporary storage unit 50 is located on the branching transport path 433. More specifically, the first temporary storage unit 50 is located between the diverter 434 and the first storage unit 45. The first temporary storage unit 50 temporarily stores banknotes. A banknote diverged by the diverter 434 to the branching transport path 433 is firstly stored in the first temporary storage unit 50. The first temporary storage unit 50 may be, for example, a reel type storage unit in which banknotes are held between tapes and are wound around a drum together with the tapes. The reel type storage unit can feed out the stored banknotes without changing the storage order of the banknotes. Although details will be described later, the banknotes fed out from the first temporary storage unit 50 are stored in the first storage unit 45.

The invalidation unit 52 is a device with a mechanical structure that invalidates physical banknotes so as not to be used. Specifically, the invalidation unit 52 is a shredder that shreds banknotes, a puncher that makes holes in banknotes, a cutter that cuts banknotes, a printer that prints on banknotes, or an ink spray that sprays ink onto banknotes. The invalidation unit 52 may be of any type as long as it can invalidate physical banknotes.

The invalidation unit 52 is located between the first temporary storage unit 50 and the first storage unit 45 on the branching transport path 433. The invalidation unit 52 invalidates the banknotes fed out from the first temporary storage unit 50. The first storage unit 45 stores the banknotes invalidated by the invalidation unit 52.

Here, the first temporary storage unit 50, the invalidation unit 52, and the first storage unit 45 are stored in a first storage section 581. Both the first temporary storage unit 50 and the first storage unit 45 store banknotes to be digitized. Only banknotes that have been recognized by the recognition unit 44 and are to be digitized, are stored in the first storage section 581.

The first storage unit 45 is detachably mounted to the first storage section 581. The operator can open the first open/close door 583 from the rear side of the money handling apparatus 4, and take the first storage unit 45 out of the first storage section 581. The operator can dismount the first storage unit 45 from the upper housing 57 and collect the invalidated banknotes stored in the first storage unit 45.

Each of the second storage unit 46 is a storage with a structure. The second storage units 46 also store the recognized money. Each second storage unit 46 may be, for example, a stacking type storage unit in which banknotes are stacked and stored. The second storage unit 46 can feed out the stored banknotes. The second storage unit 46 may be incapable of feeding out the stored banknotes. The second storage unit 46 is connected to the loop transport path 431. The money handling apparatus 4 includes a plurality of second storage units 46. The plurality of second storage units 46 are connected in parallel with respect to the loop transport path 431. A banknote to be received and not to be digitized is selectively stored in any of the second storage units 46, as described later. Money fed out from any second storage unit 46 is transported by the transport unit 43 to the dispensing unit 49 via the loop transport path 431.

The second storage units 46 are stored in a second storage section 582. That is, the second storage units 46 are located outside the first storage section 581.

The third storage units 54 are stored in the second storage section 582. Each third storage unit 54 may be, for example, a reel type storage unit. The third storage unit 54 can store and feed out banknotes. The third storage unit 54 may store a plurality of denominations of money in a mixed state. The money handling apparatus 4 includes a plurality of third storage units 54. The plurality of third storage units 54 may store banknotes for each denomination, for example. The plurality of third storage units 54 are connected in parallel with respect to the loop transport path 431.

The fourth storage unit 55 is stored in the second storage section 582. The fourth storage unit 55 may be, for example, a stacking type storage unit. The fourth storage unit 55 may store, for example, banknotes that are not stored in the second storage units 46. The fourth storage unit 55 may be a storage unit that is used as a temporary storage unit when, for example, a reconciliation process of checking the inventory amounts in the second storage units 46 is performed. Moreover, the fourth storage unit 55 may store banknotes to be collected among the banknotes stored in the second storage units 46. The fourth storage unit 55 is included in the category of the second storage unit because it stores the banknotes having been stored in the second storage units 46. The fourth storage unit 55 is connected to the loop transport path 431. The fourth storage unit 55 is detachably mounted to the second storage section 582. The operator can open the second open/close door 584 from the front side of the money handling apparatus 4, and take the fourth storage unit 55 out of the second storage section 582.

The fifth storage unit 56 is located in the upper housing 57. The fifth storage unit 56 may be, for example, a stacking type storage unit. The fifth storage unit 56 is connected to the loop transport path 431. The fifth storage unit 56 may store, for example, a banknote that is a counterfeit note or a note suspected to be a counterfeit note. That is, the money handling apparatus 4 stores a banknote, which has been recognized as a counterfeit note or a note suspected to be a counterfeit note by the recognition unit 44, into the fifth storage unit 56 without returning the banknote to the user.

The second temporary storage unit 51 is located in a rear part of the upper housing 57. The first temporary storage unit 50 and the second temporary storage unit 51 are arranged in the up-down direction in the rear part of the money handling apparatus 4. The second temporary storage unit 51 may be a reel type storage unit. The second temporary storage unit 51 temporarily stores banknotes to be received and not to be digitized. After the user has performed a confirmation operation, the second temporary storage unit 51 feeds out the banknotes being stored therein. The transport unit 43 transports the fed-out banknotes to, for example, the second storage unit 46.

The communication unit 53 communicates with the outside. The communication unit 53 is connected to a network 24 (e.g., the Internet), and performs communication via the network 24.

An account management server 25 and a digital currency management server 26 are connected to the network 24. The money handling apparatus 4, the account management server 25, and the digital currency management server 26 are communicable with each other via the network 24. The account management server 25 is a server that manages bank accounts. The account management server 25 performs a process of depositing money into an account of a user in accordance with a receiving process in the money handling apparatus 4, as described later. The digital currency management server 26 performs a process of converting physical money into digital currency, based on a request for conversion into digital currency from the money handling apparatus 4, as described later. The digital currency management server 26 is operated by, for example, the central bank.

The controller 47 includes at least a processor, a memory, and an I/F circuit. The processor executes a program. The memory stores programs and data for operating the money handling apparatus 4. The memory is, for example, a random access memory (RAM) and/or a read only memory (ROM). The I/F circuit inputs and outputs an electric signal between the controller 47 and each unit connected to the controller 47.

The controller 47 receives the operation signal from the input unit 41 and the recognition signal from the recognition unit 44, and outputs a control signal to each of the units including the transport unit 43, as described later.

### <Procedure of Digital Depositing Process of Money Handling Apparatus>

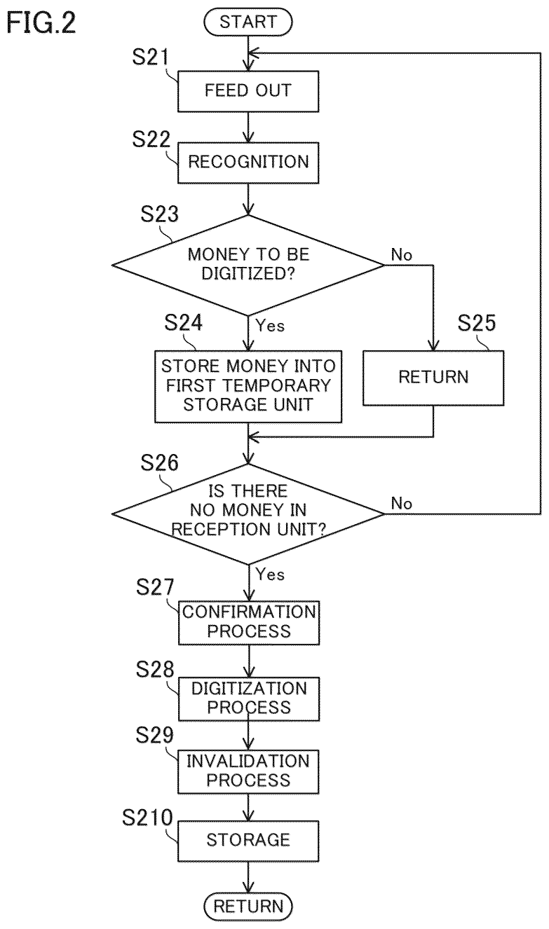

Next, the basic procedure of the receiving process performed by the money handling apparatus 4 will be described with reference to FIG. 2. As described above, in the receiving process, the money handling apparatus 4 converts a part or all of physical banknotes to be received into digital currency. In addition, as an example of the receiving process, the money handling apparatus 4 can perform a process of depositing the digital currency into a bank account. Hereinafter, this process is referred to as digital depositing or a digital depositing process. The money handling apparatus 4 can also perform a process of, without converting the physical banknotes to be received into digital currency, depositing money equivalent in value to the physical banknotes into the bank account. This process is referred to as normal depositing or a normal depositing process. Hereinafter, the procedure of the receiving process will be described, taking as an example a case where the user digitally deposits all the banknotes to be received into his/her own bank account. The procedure is substantially the same even if the user digitally deposits a part of the banknotes to be received into his/her own bank account, or the user digitally deposits a part or all of the banknotes to be received into a bank account of another person (so-called transfer). Furthermore, even if the destination of depositing is a digital wallet, the procedure is substantially the same.

Firstly, the user performs a login operation through the input unit 41. Information inputted through the login operation includes information on an account number and a password. The input unit 41 outputs, to the controller 47, an operation signal including the password inputted through the login operation. The money handling apparatus 4 makes an inquiry to the account management server 25 via the network 24. The account management server 25 confirms the account of the user. If the account confirmation is successful, the account management server 25 transmits an approval signal for the user to the money handling apparatus 4.

Upon receiving the approval signal, the money handling apparatus 4 performs a notification process of notifying the user that a depositing process is allowed. The user performs a receiving operation through the input unit 41. Information inputted through the receiving operation includes at least information on “receiving process execution request”. The information inputted through the receiving operation may include information on “type of the receiving process” or “whether or not conversion into digital currency is necessary”. Furthermore, the information inputted through the receiving operation may include at least one piece of information among “amount to be converted into digital currency”, “denomination to be converted into digital currency”, and “quantity of money to be converted into digital currency”. The user may convert all the banknotes to be received into digital currency, or may convert a part of the banknotes into digital currency. The input unit 41 outputs an operation signal including these pieces of information to the controller 47.

The controller 47 of the money handling apparatus 4 starts the receiving process, based on the operation signal. Specifically, the user inserts physical banknotes to be received into the reception unit 42, and the reception unit 42 feeds out the banknotes one by one into the apparatus (step S21). The recognition unit 44 recognizes the banknotes sent out from the reception unit 42 into the apparatus, one by one (step S22). The recognition unit 44 recognizes, for example, authenticity, currency, denomination, version, and fitness of each banknote. Furthermore, the recognition unit 44 reads an identification number, e.g., a serial number, of each banknote. The recognition unit 44 may take an image of each banknote.

The controller 47 of the money handling apparatus 4 sorts the recognized banknotes, based on the recognition signal from the recognition unit 44. Specifically, the controller 47 determines whether or not the recognized money is money to be digitized (step S23). If the operation signal includes information related to the money to be digitized, the controller 47 of the money handling apparatus 4 may sort the recognized banknotes, based on the operation signal and the recognition signal of the recognition unit 44.

For example, the money handling apparatus 4 may determine that old series notes are to be digitized and new series notes are not to be digitized. Since old series notes are not suitable for circulation in the market, it is appropriate to convert old series notes into digital currency, and invalidate them. The money handling apparatus 4 may determine that an old series note that is older than a predetermined version, among old series notes, is not to be digitized. That is, the money handling apparatus 4 may determine that an old series note for which the recognition unit 44 does not have a template, is not to be digitized.

The money handling apparatus 4 may determine that, for example, domestic currency notes are to be digitized and foreign currency notes are not to be digitized. This is because foreign currency notes cannot be converted into digital currency and invalidated.

The money handling apparatus 4 may provide the user with information on money that can be handled by the money handling apparatus 4, when the user inserts banknotes to be received into the reception unit 42. Templates possessed by the recognition unit 44 limit the versions of old series notes and/or the currencies that can be received by the money handling apparatus 4. The money handling apparatus 4 may display, for example, images of money in versions that can be converted into digital currency and/or money in versions that cannot be converted into digital currency, on the display. Likewise, the money handling apparatus 4 may present the user with information on currencies that can be converted into digital currency and/or currencies that cannot be converted into digital currency, through the display. Moreover, the money handling apparatus 4 may present the user with information on denominations that can be converted into digital currency and/or denominations that cannot be converted into digital currency, through the display.

The money handling apparatus 4 may determine that, for example, unfit notes are to be digitized and fit notes are not to be digitized. This is because unfit notes are not suitable for circulation on the market. The money handling apparatus 4 may change a fitness threshold value as a decision criterion for digitization, according to an operation of the operator. Also, the money handling apparatus 4 has a fitness threshold value for determining whether or not a banknote is recyclable, in addition to the fitness threshold value as the decision criterion for digitization. These two fitness threshold values may be the same or different from each other.

The money handling apparatus 4 may determine that, for example, large-denomination notes are to be digitized and small-denomination notes are not to be digitized.

The money handling apparatus 4 determines whether or not a banknote to be received is money to be digitized, based on the identification number of the banknote to be received. The money handling apparatus 4 may determine whether or not a banknote is a stolen note or a counterfeit note, based on the identification number, for example, and may not digitize a stolen note or a counterfeit note. Meanwhile, based on the identification number, an issuing bank and/or a printing office of a banknote may be specified, or the issue year of the banknote may be specified. The money handling apparatus 4 may determine whether or not the banknote is money to be digitized, based on the issuing bank, the printing office, or the issue year obtained from the identification number.

If the determination in step S23 is “YES”, the controller 47 outputs a control signal to the transport unit 43 so that the banknote to be digitized is stored in the first storage unit 45. Based on the control signal from the controller 47, the transport unit 43 transports the banknote to be digitized toward the first temporary storage unit 50 by using the diverter 434 (step S24, see a solid-line arrow in FIG. 1). If the determination in step S23 is “NO”, the controller 47 outputs a control signal to the transport unit 43 so that the banknote not to be digitized is returned to the user via a return unit. The return unit is a return port with a mechanical structure. Based on the control signal from the controller 47, the transport unit 43 transports the banknote not to be digitized toward the dispensing unit 49 by using the diverter 434 (step S25, see a broken-line arrow in FIG. 1). The banknote to be digitized is stored in the first temporary storage unit 50, and the banknote not to be digitized is held in the dispensing unit 49. The dispensing unit 49 is an example of the return unit. Banknotes not to be digitized also include a so-called reject note that the money handling apparatus 4 cannot accept based on the result of the recognition by the recognition unit 14. Moreover, the transport unit 43 may transport a stolen note or a counterfeit note to the fifth storage unit 56 without returning the same to the user.

The money handling apparatus 4 may store a banknote to be received and not to be digitized into any second storage unit 46 without returning the same to the user, and may perform a normal depositing process for this banknote. That is, in step S25, the transport unit 43 may transport the recognized banknote to the second temporary storage unit 51 so that the banknote to be received and not to be digitized is stored in the second storage unit 46. In this case, the second temporary storage unit 51 stores the banknote not to be digitized.

The controller 47 determines whether or not banknotes remain in the reception unit 42 (step S26). If the determination in step S26 is “YES”, the process proceeds to step S27. If the determination in step S26 is “NO”, the process returns to step S21, and the reception unit 42 continues feeding of banknotes. When the reception unit 42 has sent out all the banknotes to be received and the recognition unit 44 has recognized all the banknotes, the money handling apparatus 4 presents the user with a counting result of the banknotes taken into the apparatus. When the user checks the counting result and performs a confirmation operation through the input unit 41, the money handling apparatus 4 performs a confirmation process (step S27). Through the confirmation process, the banknotes stored in the first temporary storage unit 50 are confirmed as banknotes to be converted into digital currency.

When the user performs the confirmation operation, the money handling apparatus 4 may allow the user to select banknotes to be converted into digital currency and/or banknotes not to be converted into digital currency. If the selection causes both banknotes to be converted into digital currency and banknotes not to be converted into digital currency to be included in the banknotes to be received, the money handling apparatus 4 performs a digital depositing process described below and a normal depositing process in parallel.

After the confirmation process, the money handling apparatus 4 performs a digitization process (step S28). Specifically, the money handling apparatus 4 outputs a request signal to the digital currency management server 26 via the network 24. The request signal requests conversion of a physical banknote to be digitized into digital currency. The request signal includes information on the banknote to be digitized, specifically, the ID that identifies the banknote, the denomination of the banknote, and the recognition data. The ID is an identification number that is read by the recognition unit 44. If the money to be digitized is a coin, the ID that identifies the money is an ID that is generated by the money handling apparatus 4 and is unique for each denomination. The recognition data is information on the version of the banknote, information on the fitness of the banknote, and/or a captured image of the banknote. The request signal may include information that identifies the user who has performed the digital depositing process (i.e., user ID), and information that identifies an account in which the digital currency is to be deposited (i.e., account ID). In addition, the request signal may include information that identifies the money handling apparatus 4 (i.e., money handling apparatus ID).

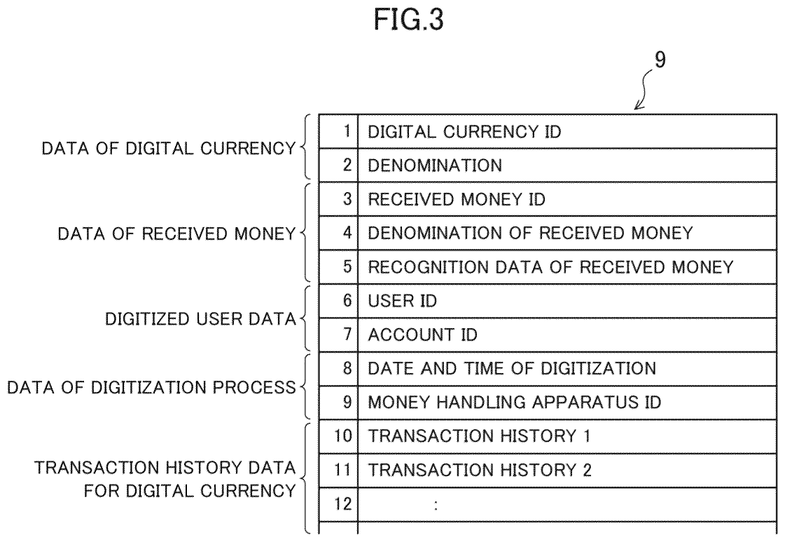

Upon receiving the digitization request signal, the digital currency management server 26 performs a digitization process. Specifically, the digital currency management server 26 creates data of digital currency. FIG. 3 exemplarily illustrates a data structure 9 of digital currency. The data of digital currency includes a digital currency ID assigned to the digital currency, and information on the denomination. Information on the physical money before conversion into the digital currency, i.e., information on the received money, may be included in the data of digital currency. This information is information transmitted from the money handling apparatus 4 to the digital currency management server 26, and is information on the received money ID that identifies the banknote, the denomination, and the recognition data, for example. The data of digital currency further includes the user ID that has performed the digital depositing process, and the account ID that identifies the account to which the digital currency is to be deposited. Moreover, the data of digital currency may include information on the date and time of digitization, and the money handling apparatus ID that specifies the money handling apparatus. In addition, the data of digital currency may include information on transaction history of digital currency after the digitization. The transaction history is added to the data of digital currency each time a transaction of the digital currency is performed. The transaction history includes an ID that identifies the transaction person, the transaction history, the transaction content, and information that specifies the used handling apparatus or application. In the data of digital currency, link information for accessing the aforementioned pieces of data may be included instead of including the pieces of data as they are. The digital currency management server 26 may manage the generated digital currency by using a block chain, for example.

Upon completing the digitization process, the digital currency management server 26 transmits a completion signal to the money handling apparatus 4 via the network 24. Upon receiving the completion signal, the money handling apparatus 4 performs an invalidation process (step S29). The invalidation process is a process of invalidating, with the invalidation unit 52, the physical banknote converted into the digital currency. Specifically, the first temporary storage unit 50 feeds out the stored banknotes, and the invalidation unit 52 invalidates the banknotes. Then, the first storage unit 45 stores the invalidated banknotes (step S210).

The digital currency management server 26 performs a depositing instruction to the account management server 25 via the network 24. The account management server 25 performs a process of depositing the digital currency into the account of the user. Thus, the digital depositing process is completed.

Thus, the user can convert the physical banknotes inserted in the money handling apparatus 4 into digital currency, and deposit the digital currency into the bank account.

If the user desires to deposit the digital currency into a digital wallet instead of or in addition to the bank account, the account management server 25 performs a process of depositing the digitized money into the digital wallet of the user. The depositing process into the digital wallet may be performed by a server other than the account management server 25.

If the second temporary storage unit 51 stores a banknote to be received and not to be digitized, after the confirmation operation of the user, the second temporary storage unit 51 feeds out the banknote not to be digitized, and the transport unit 43 transports the banknotes to any of the second storage units 46. The second storage unit 46 stores the banknote. The money handling apparatus 4 can manage the banknotes to be digitized and the banknotes not to be digitized separately from each other by using the first storage unit 45 and the second storage unit 46. The banknote stored in the second storage unit 46 is not invalidated. The money handling apparatus 4 can provide the user with the banknote stored in the second storage unit 46 when performing a dispensing process, for example.

When the second storage unit 46 stores the banknote, the account management server 25 performs, as a normal depositing process, a process of depositing money equivalent in value to the banknote not to be digitized, into the account of the user.

As described above, in the receiving process, the controller 47 of the money handling apparatus 4 determines whether or not a banknote to be received is money to be digitized, based on the recognition signal from the recognition unit 44, and outputs a control signal so that the banknote to be digitized is stored in the first storage unit 45. The money handling apparatus 4 can discriminate between the money to be digitized and the money not to be digitized, based on the recognition signal.

The invalidation unit 52 invalidates the money to be digitized before it is stored in the first storage unit 45. The money stored in the first storage unit 45 is unusable money. The money handling apparatus 4 can safely manage the money to be digitized.

(Process of Converting Substitute Money into Digital Currency)

As described above, money converted into digital currency is invalidated. Even if the user specifies conversion of money into digital currency, it is sometimes preferable to circulate the money without being invalidated if the money can still be circulated. For example, it is preferable to circulate a new series note or a fit note in a less soiled state without being invalidated. Even if the user specifies digitization of money, the money handling apparatus may not invalidate the money if the money satisfies a certain condition.

If money is not invalidated, this money cannot be converted into digital currency. In this case, among money to be received, the quantity of money to be converted into digital currency decreases. Therefore, if the money handling apparatus does not convert money to be received into digital currency, the money handling apparatus converts money stored therein into digital currency, as substitute money.

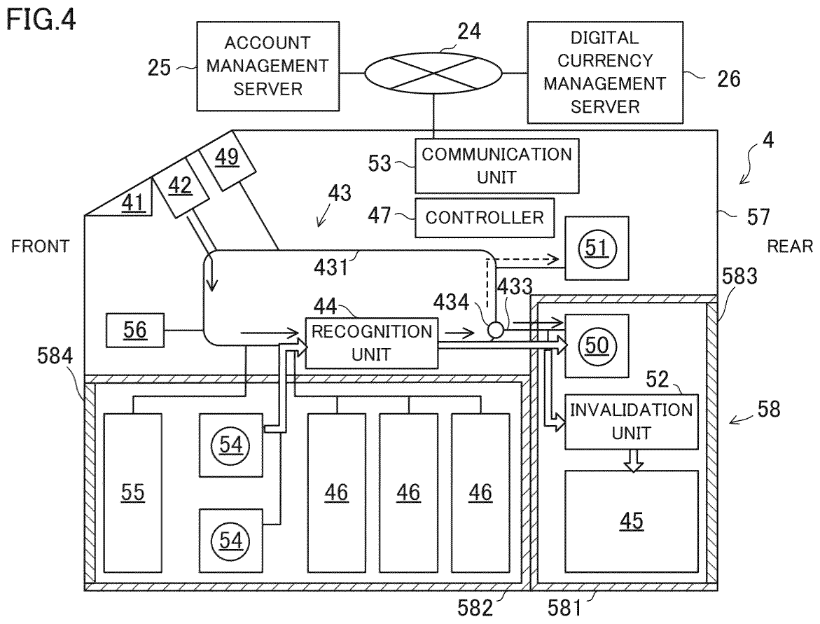

FIG. 4 exemplarily illustrates a banknote transport path in the case where substitute banknotes are converted into digital currency in the money handling apparatus 4. In the example shown in FIG. 4, it is assumed that substitute banknotes are stored in the third storage unit 54. The third storage unit 54 may store a plurality of denominations of banknotes in a mixed state, as described above. The third storage unit 54 may store unfit notes. An unfit note is, for example, a note the degree of soiling of which is higher than the standard. Unfit notes are preferably removed from circulation on the market, and therefore are suitable as substitute banknotes to be invalidated. The third storage unit 54 may store an unfit note for which the user has not requested conversion into digital currency in the receiving process.

As described above, the transport unit 43 of the money handling apparatus 4 transports a banknote to be received, which is determined as a banknote to be digitized, to the first temporary storage unit 50 (see a solid-line arrow in FIG. 4). Moreover, the transport unit 43 transports a banknote that is determined as a banknote not to be digitized based on the recognition result, to the second temporary storage unit 51 (see a broken-line arrow in FIG. 4).

After the confirmation operation of the user, the third storage unit 54 receives a control signal of the controller 47, and feeds out a substitute banknote equivalent in value to the banknote stored in the second temporary storage unit 51. The substitute banknote may be a banknote of the same denomination as the banknote not to be digitized. The substitute banknote may be a plurality of banknotes each being smaller in denomination than the banknote not to be digitized. The substitute banknote may be one banknote equivalent in value to the total of a plurality of banknotes not to be digitized.

The transport unit 43 transports the substitute banknote fed out from the third storage unit 54, to the recognition unit 44. The substitute banknote recognized by the recognition unit 44 is transported by the transport unit 43 to the first temporary storage unit 50, and the first temporary storage unit 50 stores the recognized substitute banknote (see an outlined arrow in FIG. 4). Thus, a physical banknote equivalent in value to the banknote for which the user has requested digitization, is stored in the first temporary storage unit 50.

Thereafter, upon completion of the digitization process for the banknote to be digitized including the substitute banknote, the first temporary storage unit 50 feeds out the stored banknote, and the invalidation unit 52 invalidates the fed-out banknote. The first storage unit 45 stores the invalidated banknote (see an outlined arrow in FIG. 4). In addition, the second temporary storage unit 51 feeds out the stored banknote, and the transport unit 43 transports the fed-out banknote to the second storage unit 46, the third storage unit 54, or the fourth storage unit 55. The second storage unit 46, the third storage unit 54, or the fourth storage unit 55 stores the banknote.

Instead of the third storage unit 54, the second storage unit 46 may feed out the substitute banknote.

If no substitute banknote is stored in the third storage units 54 (and the second storage units 46), the money handling apparatus 4 may remember this fact, and when a banknote is newly received in or supplied to the money handling apparatus 4, the money handling apparatus 4 may digitize and invalidate the received or supplied banknote as a substitute banknote. That is, the timing at which a physical banknote is converted into digital currency may be different from the timing at which a substitute banknote is invalidated.

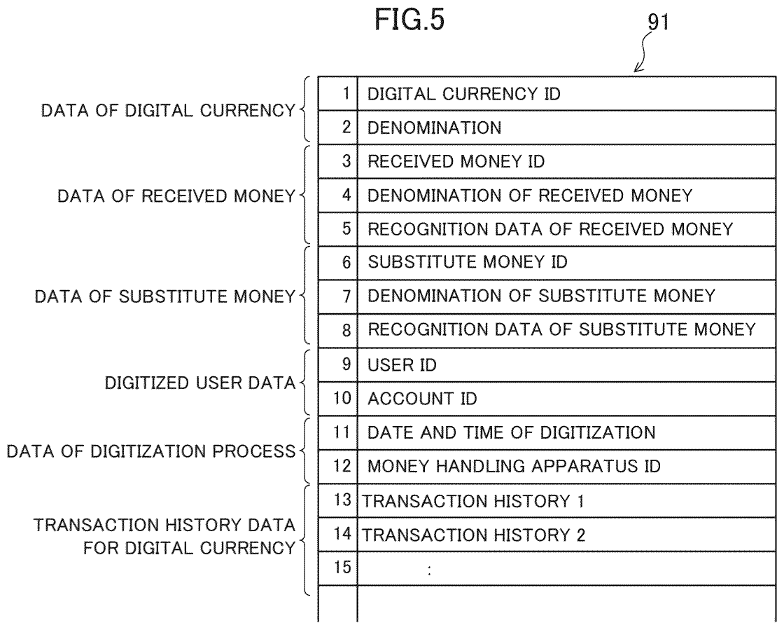

FIG. 5 exemplarily illustrates a data structure 91 of digital currency generated by the digital currency management server 26, regarding a substitute banknote. When a substitute banknote is used, data of digital currency may include data of the substitute money, i.e., the substitute money ID that identifies the substitute money, the denomination of the substitute money, and the recognition data.

### (Modification Regarding Handling of Substitute Money)

Even when the user does not request conversion into digital currency, if a specific condition is satisfied, the money handling apparatus 4 may convert money to be received that is inserted by the user, into digital currency. For example, if money to be received is an unfit note, the unfit note is preferably removed from circulation on the market, as described above. When the money to be received is an unfit note, the money handling apparatus 4 may request the digital currency management server 26 to convert the unfit note into digital currency and may invalidate the unfit note, regardless of presence/absence of a request for conversion into digital currency. If the user does not request conversion into digital currency, generated digital currency cannot be deposited in the account of the user. The money handling apparatus 4 may store the generated digital currency in the memory to manage the same. The digital currency managed by the money handling apparatus 4 can be used as substitute digital currency in another receiving process. Alternatively, the digital currency management server 26 may manage the generated digital currency.

### (Money Change Process)

The money handling apparatus 4 may perform, as the receiving process, a money change process instead of a depositing process into an account. In the money change process, the money handling apparatus 4 may convert at least a part of physical money as a change source into digital currency. The money change process includes both a case where money as a change destination is physical money and a case where it is digital currency.

For example, if money as a change source, which has been inserted into the money handling apparatus 4 by the user, is an unfit note, this unfit note is allowed to be invalidated. As described above, the money handling apparatus 4 may convert the unfit note into digital currency and invalidate the unfit note even if the user does not request conversion into digital currency. If money as a change destination is digital currency, the money handling apparatus 4 dispenses digital currency. If money as the change destination is physical money, the money handling apparatus 4 dispenses physical money that is equivalent in value to the generated digital currency. The generated digital currency may be managed by the money handling apparatus 4. Alternatively, the digital currency management server 26 may manage the generated digital currency.

The money as the change destination, which is dispensed to the user in the money change process, may be of the same denomination as the money as the change source. This money change corresponds to, for example, money change from an unfit note to a fit note, or money change from an old series note to a new series note. The money as the change destination may be a plurality of pieces of money each being smaller in denomination than the money as the change source.

The money change process is not limited to money change in the same currency, and may be money change to a foreign currency. For example, if money to be received is money of a foreign currency, the money handling apparatus 4 may convert the money to a domestic currency according to an exchange rate, convert the substitute banknote stored in the money handling apparatus 4 into digital currency, and dispense the digital currency to the user. Moreover, for example, if money to be received is money of a domestic currency, the money handling apparatus 4 may convert the money to a foreign currency according to an exchange rate, and dispense physical money of the foreign currency. Meanwhile, the money handling apparatus 4 may convert the received money of the domestic currency into digital currency, and invalidate the received money.

The aforementioned conversion into digital currency corresponds to conversion into fixed-value digital currency. The fixed-value digital currency has a fixed unit of transaction, like physical money. That is, for example, fixed-value digital currency of 1,000 yen can be traded only as 1,000 yen.

In contrast to fixed-value digital currency, there is variable-value digital currency. For the variable-value digital currency, the unit of transaction can be arbitrarily set. For example, variable-value digital currency of 1,000 yen can be traded at any value from 1 yen to 1,000 yen.

The digital currency management server 26 generates fixed-value digital currency, and the money handling apparatus 4 handles the fixed-value digital currency. The fixed-value digital currency has a data structure including denomination, and has information on transaction history, as exemplarily illustrated in FIG. 3 or FIG. 5. Such a data structure of fixed-value digital currency enables tracing of individual transactions of digital currency.

Since digital currency is of the fixed-value type, the system including the money handling apparatus 4 and the digital currency management server 26 is capable of (1) generating digital currency having the same value as physical money, (2) generating a plurality of pieces of digital currency by dividing the value of physical money, and (3) generating one piece of digital currency by integrating the values of a plurality of pieces of physical money.

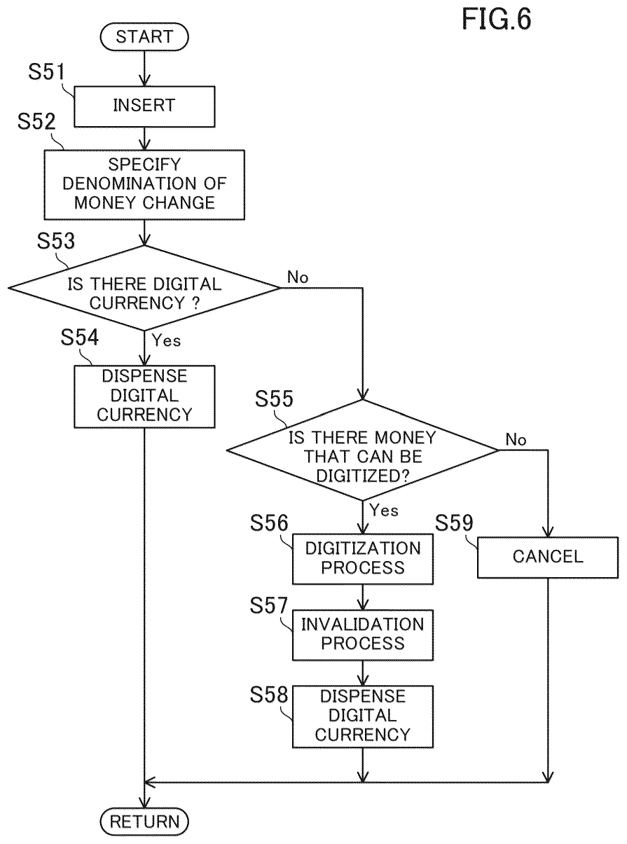

Hereinafter, the procedure of a money change process that is an example of the receiving process performed by the money handling apparatus 4 will be described with reference to FIG. 6. This money change process is a process of changing physical money or digital currency (i.e., change source) to digital currency (i.e., change destination). Firstly, the user inserts money as a change source into the money handling apparatus 4 (step S51). The money as the change source may be physical money or digital currency. The user specifies the denomination of the change destination through the input unit 41 (step S52). The denomination of the change destination may be the same as or different from the denomination of the change source.

Upon receiving the request operation of the user, the money handling apparatus 4 determines whether or not it has the digital currency as the change destination (step S53). If the determination in step S53 is “YES”, the process proceeds to step S54. The money handling apparatus 4 dispenses the digital currency as the change destination (step S54). Specifically, the money handling apparatus 4 dispenses the digital currency as the change destination to the account or digital wallet of the user. The money handling apparatus 4 may dispense the digital currency to the account or digital wallet of the user through the digital currency management server 26.

If the determination in step S53 is “NO”, the process proceeds to step S55. The money handling apparatus 4 determines whether or not it has physical money that can be converted into digital currency. In this case, the physical money is money that is stored in a storage unit capable of at least feeding out money, specifically, the second storage unit 46 or the third storage unit 54. If the determination in step S55 is “YES”, the process proceeds to step S56. If the determination in step S55 is “NO”, the process proceeds to step S59. If the money handling apparatus 4 does not have physical money that can be converted into digital currency, the money handling apparatus 4 cancels the money change process (step S59). The physical money or digital currency as the source of money change is returned to the user.

Meanwhile, if the money handling apparatus 4 has physical money that can be converted into digital currency, the money handling apparatus 4 performs a digitization process (step S56). Specifically, a storage unit that stores the money to be digitized (e.g., third storage unit 54) feeds out the money, and the transport unit 43 transports the fed-out money to the recognition unit 44. After the recognition unit 44 has recognized the money, the transport unit 43 transports the recognized money to the first temporary storage unit 50. The first temporary storage unit 50 stores the money to be digitized (see an outlined arrow in FIG. 4).

The money handling apparatus 4 requests the digital currency management server 26 to digitize the money, and the digital currency management server 26 converts the money into digital currency. Upon completion of the digitization process, the money handling apparatus 4 invalidates the money stored in the first temporary storage unit 50 (step S57). Specifically, as described above, the money fed out from the first temporary storage unit 50 is transported to the invalidation unit 52, and the invalidation unit 52 invalidates the money. The invalidated money is stored in the first storage unit 45. When the physical money has been converted into digital currency, the money handling apparatus 4 dispenses the digital currency as the change destination to the account or digital wallet of the user.

This money change process will be described with specific examples. It is assumed that the user requests money change from a physical banknote of 10,000 yen or fixed-value digital currency of 10,000 yen to fixed-value digital currency of 1,000 yen.

If the money handling apparatus 4 has ten pieces of digital currency of 1,000 yen, the money handling apparatus 4 dispenses the digital currency (step S54). If the money handling apparatus 4 stores ten 1,000-yen banknotes that can be converted into digital currency, the money handling apparatus 4 converts the banknotes into digital currency and dispenses the digital currency (step S58). If the money handling apparatus 4 stores 5,000-yen banknotes or a 10,000-yen banknote, the money handling apparatus 4 can convert the physical banknote(s) into ten pieces of digital currency of 1,000 yen by dividing the value of the physical banknotes.

If the money handling apparatus 4 does not have digital currency and does not store physical money that can be converted into digital currency, the money handling apparatus 4 cancels the money change process (step S59).

Contrary to the above example, it is assumed that the user requests money change from ten physical banknotes of 1,000 yen or ten pieces of fixed-value digital currency of 1,000 yen to fixed-value digital currency of 10,000 yen.

If the money handling apparatus 4 has digital currency of 10,000 yen, the money handling apparatus 4 dispenses the digital currency (step S54). If the money handling apparatus 4 stores a 10,000-yen banknote that can be converted into digital currency, the money handling apparatus 4 converts this banknote into digital currency, and dispenses the digital currency (step S58). If the money handling apparatus 4 stores two 5,000-yen banknotes or ten 1,000-yen banknotes, the money handling apparatus 4 can convert the physical banknotes into one piece of digital currency of 10,000 yen by integrating the values of the physical banknotes.

The money handling apparatus 4 performing the above money change process is not limited to an ATM installed in a bank as described above, and may be, for example, a change machine connected to a point-of-sales (POS) register installed in a retail store. If the money handling apparatus 4 is such a change machine, a settlement process of paying for a purchased commodity can be regarded as an example of the receiving process. In a case where the user inserts money higher in amount than the price of the purchased commodity into the change machine and receives a change by digital currency in the settlement process, the procedure of the aforementioned money change process can be applied as it is to the settlement process.

### Other Embodiments

The money handling apparatus may perform a replenishment process as an example of the receiving process. If money that can be digitized is found during execution of the replenishment process, the money handling apparatus may convert this money into digital currency and invalidate the money. That is, the replenishment process is a process in which physical money for replenishment is received into the money handling apparatus through the reception unit or a replenishment cassette mounted to the apparatus, and is stored in the storage unit in the money handling apparatus. In the replenishment process, if money that can be digitized or money to be digitized is found as a result of recognition performed on the physical money for replenishment by the recognition unit, the money handling apparatus may convert the money into digital currency and invalidate the money according to the aforementioned procedure.

If money that can be digitized is found during execution of the reconciliation process, the money handling apparatus may convert this money into digital currency and invalidate the money. That is, the reconciliation process is a process of, after money stored in a storage unit is fed out and recognized, restoring the recognized money into the original storage unit. In the reconciliation process, if money that can be digitized or money to be digitized is found as a result of recognition performed on the physical money for replenishment by the recognition unit, the money handling apparatus may convert the money into digital currency and invalidate the money according to the aforementioned procedure.

When conversion into digital currency has been performed in the replenishment process or the reconciliation process, generated digital currency may be managed in the money handling apparatus, or may be managed in the digital currency management server 26.

What is claimed is:

1. A money handling apparatus, comprising:
an input receptacle receiving money and sending out the money into the apparatus;
a transport member having a transport path connected to the input receptacle, and transporting the money sent out from the input receptacle;
a recognition circuit recognizing money and outputting a recognition signal;
a first storage to which the transport path is connected, and which stores recognized money; and
a controller configured to, in a receiving process, determine whether or not the money to be received is money to be digitized, based on the recognition signal, and output a control signal so that money to be digitized is stored in the first storage.

2. The money handling apparatus according to claim 1, further comprising an invalidation device connected to the first storage, and invalidating the money to be digitized, wherein
the first storage stores invalidated money.

3. The money handling apparatus according to claim 1, wherein the controller is configured to output a depositing signal so that, in the receiving process, digital currency into which the money to be received is converted is deposited in a designated account.

4. The money handling apparatus according to claim 3, wherein the controller is configured to output a depositing signal so that, in the receiving process, money equivalent in value to the money to be received is deposited in the designated account.

5. The money handling apparatus according to claim 1, wherein the controller is configured to determine whether or not the money to be received is money to be digitized, based on at least one of version information, fitness information, currency information, and denomination information, of the money to be received, which correspond to the recognition signal.

6. The money handling apparatus according to claim 1, wherein the controller is configured to determine whether or not the money to be received is money to be digitized, based on an identification number, of the money to be received, which corresponds the recognition signal.

7. The money handling apparatus according to claim 1, further comprising a return port to which the transport path is connected, and which holds money to be returned, wherein
the controller is configured to output a control signal so that money not to be digitized is returned to the return port.

8. The money handling apparatus according to claim 1, further comprising a second storage to which the transport path is connected, and which stores money not to be digitized.

9. The money handling apparatus according to claim 8, further comprising a third storage to which the transport path is connected, and which stores substitute money for the money not to be digitized, wherein
the controller is configured to output a depositing signal so that, when the second storage stores the money not to be digitized, the substitute money is converted into digital currency, and converted digital currency is deposited in the designated account.

10. The money handling apparatus according to claim 9, wherein the controller is configured to output a control signal so that the substitute money fed out from the third storage is stored in the first storage.

11. The money handling apparatus according to claim 9, wherein information on the digital currency includes both information on the money to be received and not to be digitized, and information on the substitute money.

12. A money handling apparatus, comprising:
an input receptacle receiving money and sending out the money into the apparatus;
a transport member having a transport path connected to the input receptacle, and transporting the money sent out from the input receptacle;
a first storage to which the transport path is connected, and which stores money to be digitized among the money to be received;
a third storage to which the transport path is connected, and which feeds out money stored therein; and
a controller configured to, in a receiving process, output a control signal so that substitute money for money not to be digitized among the money to be received is fed out from the third storage, and the substitute money is stored in the first storage as the money to be digitized.

13. The money handling apparatus according to claim 12, further comprising an invalidation device connected to the first storage, and invalidating the money to be digitized, wherein
the first storage stores invalidated money.

14. The money handling apparatus according to claim 12, wherein the third storage feeds out one or a plurality of pieces of substitute money equivalent in value to the money not to be digitized.

15. A money handling method, comprising:
sending out, by an input receptacle, money to be received into a money handling apparatus;
recognizing, by a recognition circuit, the money to be received and outputting a recognition signal;
determining, by a controller, whether or not the money to be received is money to be digitized, based on the recognition signal;
transporting, by a transport member, money to be digitized to a first storage, upon receiving determination of the controller; and
storing the money to be digitized in the first storage.

16. A money handling method, comprising:
sending out, by an input receptacle, money to be received into a money handling apparatus;
storing, in a first storage, money to be digitized among the money to be received;
feeding out, by a third storage, substitute money for money not to be digitized among the money to be received; and
storing, in the first storage, the substitute money as money to be digitized.
